(19) United States
(12) Patent Application Publication
(10) Pub. No.: US 2020/0405012 A1
(43) Pub. Date: Dec. 31, 2020

(54) Absorbent Adhesive Pad for Footwear

(71) Applicant: Denise C. Hujing, Alpine, CA (US)

(72) Inventor: Denise C. Hujing, Alpine, CA (US)

(21) Appl. No.: 16/457,753

(22) Filed: Jun. 28, 2019

(51) Int. Cl. A43B 17/00; B32B 7/06; B32B 7/12

(52) U.S. Cl. CPC A43B 17/006; B32B 7/06; B32B 7/12; B32B 2437/02; B32B 2307/7265; B32B 2305/02; B32B 2307/726

(57) ABSTRACT

The present invention is an odorless absorbent adhesive pad for the inside of a shoe or sandal able to receive and maintain an aqueous or oil-based fluid, the pad contains an absorbent layer for receiving the aqueous or oil-based (e.g., an essential oil) and an upper surface and a lower surface; an aqueous and oil impermeable layer affixed to the lower surface of the absorbent layer; an adhesive layer affixed on the aqueous and oil impermeable layer for affixing the pad in the shoe or sandal; a removable protective cover affixed to the adhesive layer to prevent damage prior to use; and a protective layer affixed over the upper surface of the absorbent layer to reduce or prevent the absorbent layer from contacting a user.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### TECHNICAL FIELD

The present invention is a device that may be inserted into footwear. More specifically, a disposable absorbent adhesive pad that may be removably affixed within a shoe or sandal, easily hidden when the footwear is worn, and able to retain an aqueous or oil-based fluid being utilized by a user.

### BACKGROUND OF THE INVENTION

A variety of aqueous and oil-based fluids may be utilized in footwear for the benefit of the user. Unfortunately, no such disposable absorbent adhesive pad is commercially available for this particular application. Other similar devices are known for the treatment of foot odor resulting from perspiration. While perspiration itself is odorless, it creates a beneficial environment for certain bacteria to grow, producing odorous substances. These bacteria are naturally present on our skin as part of the human flora. Brevibacteria are considered a major cause of foot odor because they ingest dead skin on the feet and, in the process, the amino acid methionine is converted into methanethiol, with a distinctive sulfuric aroma. Propionic acid, a breakdown product of Propionibacteria amino acid metabolism in sebaceous gland ducts also present in foot sweat, produces a vinegar odor. Isovaleric acid (3-methyl butanoic acid), another source of foot odor, is produced by Staphylococcus epidermidis, that produces a cheese aroma. Other implicated microorganisms include Micrococcaceae, Corynebacterium and Pityrosporum.

The smell produced from these bacteria is exacerbated by factors that increase sweating, such as wearing closed-toe shoes. Sports footwear such as sneakers is often heavily padded inside, which provides a perfect environment to trap moisture and allow the bacteria to thrive. Given that socks directly contact the feet, their composition can affect foot odor. Synthetic materials like polyester and nylon afford less ventilation to the foot than do cotton or wool, leading to increased perspiration, and as a result, increased odor.

A variety of devices have been developed in an attempt to control the odor produced in footwear. For example, U.S. Pat. No. 9,456,660 discloses a shoe insert that may be removably positioned within a shoe having a panel the size and shape of the insole of a shoe, a covering made of a compressible foam elastomeric material having a plurality of apertures and a middle layer containing a scented gel. However, this device has a number of problems. First, the thickness of the device reduces the space available for the foot, which can cause discomfort. Second, the device is specific to the user's foot size. Consequently, a number of these devices must be produced to provide the appropriate selection of sizes for the consumer. Third, devices of this size are undesirable for use with sandals or other open-toe shoes. Forth, this device is provided with a particular scented gel. Consequently, to accommodate a variety of customer preferences, the manufacturer would have to produce the inserts in a variety of scents. This factor multiplied by the variety of sizes that would have to be produced substantially increases the stock that a seller would have to maintain for their customers. Similar devices are disclosed in U.S. Pat. Nos. 4,192,086, 4,257,176, 4,517,308, 4,864,740, 5,261,169, 7,047,671 and U.S. patent application publication number 2008/115,385.

Another device provides a sole for shoes having wells or cut-outs in which scented or absorbent materials may be inserted. For example, U.S. Pat. No. 5,829,167 discloses a shoe having a sole in which a pair of unitary flexible housings having a plurality of breathing apertures and containing a predetermined amount of charcoal particles and medicated powder may be inserted one near the ball of the foot and one near the heal. However, this device has problems. First, the placement of these flexible housings are at two critical pressure points within a shoe and receive a majority of the impact during use. The potential for the contents of these housings to shift and become uneven during use is high. This can make the sole uneven and uncomfortable for the user. Second, the potential for the contents of the housings to be crushed or escape into the shoe compartment is high. If the contents of the housing contain charcoal, then it can discolor the inside of the shoe, sock and foot of the user. Third, the thickness of the sole is reduced in the area where the housings are placed. Consequently, the lifespan of the shoe is correspondingly reduced during normal use. A similar device having an odor and moisture absorbing pad sandwiched between the insole of the shoe and the top surface of the outer sole of the shoe, is disclosed in U.S. Pat. No. 6,922,918.

Another device described in U.S. Pat. No. 5,399,404 provides a patch for a foot or a shoe that masks odors having a non-occlusive layer with a carrier layer containing about 10 to about 80 mg of fragrance on one side and a pressure sensitive adhesive on the other side. However, this device has problems. First, it provides about 10-80 mg of a fragrance, and because not all users will appreciate a single fragrance, a variety of devices must be produced with different fragrances to appeal to the consumer. Second, there is no protective layer preventing the fragrance from contacting the skin of the user (i.e., layer 2 in FIG. 1 and layer 5 in FIG. 2). This can be a potential problem since a portion of the population may be allergic to certain fragrances and the application of these devices in a shoe or on the skin of such a user could cause significant skin irritation. Similar devices are disclosed in U.S. Pat. Nos. 5,732,485 and 6,227,458.

Consequently, there is a need in the industry for a disposable absorbent adhesive pad that: may be utilized with footwear for maintaining aqueous or oil-based fluids; may be utilized with all shoe sizes or is of a size that can be easily hidden during use such as with a sandal; does not compromise the structural integrity of the footwear; does not occupy a significant amount of space in the footwear designated for the user's foot; does not have a fragrance; and constructed in a way that reduces contact between the user's skin and the fluid that may be applied to the device during use.

The forgoing examples of related art and limitations related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### SUMMARY OF THE INVENTION

The present invention is a disposable absorbent adhesive pad for the inside of a shoe or sandal able to receive and maintain an aqueous or oil-based fluid. The pad contains an absorbent layer for receiving the aqueous or oil-based fluid (e.g., an essential oil) having an upper surface and a lower surface; an adhesive layer affixed to the lower surface of the absorbent layer for affixing the pad in the shoe or sandal, wherein the adhesive layer acts as an aqueous and oil impermeable barrier; a removable protective cover affixed to the adhesive layer to prevent damage prior to use; and a protective layer affixed over the upper surface of the absorbent layer to reduce or prevent the absorbent layer from contacting a user.

In one embodiment, the pad may further contain a removable sterile cover fitted over the protective layer to maintain the pad in sterile form prior to use, a transfer layer between the absorbent layer and the protective layer to assist in actively transferring a fluid from the protective layer to the absorbent layer and/or an aqueous and oil impermeable layer between the adhesive layer and the absorbent layer to reduce contact of the fluid or oil deposited on the pad with the skin of the user. The size of the pad is less than about 1/20 to about 1/50 the size of the inside sole of the shoe. The protective layer may be made of a natural biopolymer. The aqueous and oil impermeable layer may be made of a compostable bioplastic. Alternatively, the aqueous and oil impermeable layer may be made of cellophane. The adhesive may be plant-based glue, such as dextrin. The removable protective cover may be a polymer coated sheet such as polymer coated paper, for example, paper coated with a natural or synthetic wax.

In another embodiment, the pad may further comprise a transfer layer between the protective layer and the absorbent layer, wherein the transfer layer allows the transfer of an aqueous or oil-based fluid received by the pad to the absorbent layer. The transfer layer may be made of a porous natural biopolymer for example a porous natural biopolymer such as porous wood pulp.

In yet another embodiment, the pad may further comprise an essential oil.

Another aspect of the present invention is a kit containing one or more of the disposable absorbent adhesive pads for the inside of a shoe or sandal able to receive and maintain an aqueous or oil-based fluid and one or more containers each containing an essential oil.

In yet another aspect, the present invention is a method of using the disposable absorbent adhesive pad comprising the steps of obtaining an odorless pad, applying an aqueous or oil-based fluid to the absorbent layer through the protective layer and allowing the essential oil to be absorbed by the absorbent layer, removing the removable protective cover from the adhesive layer and affixing the pad in a shoe or sandal.

### BRIEF DESCRIPTION OF THE DRAWINGS

FIG. 1 is a cross-sectional view of the absorbent adhesive pad 10 of the present invention showing 14 a sterile cover, 2 the protective layer, 4 the absorbent layer, 6 the adhesive layer and 12 the removable protective cover. The thickness of these layers is merely provided for easy visualization. It is not provided for determining the relative thickness of one layer as compared to another.

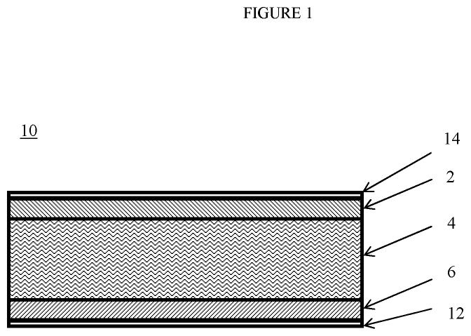

### DETAILED DESCRIPTION OF THE INVENTION

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this section prevail.

The term “affix”, “affixes” or “affixed” as used herein refers to any method known in the art to deposit, adhere, fuse, weld or otherwise connect one layer of the device to another layer. Affixing can include spray deposition of one layer onto another (e.g., spray depositing the aqueous and oil impermeable layer on the lower surface of the absorbent layer), adhesively binding one layer to another, heat fusing one layer to another, melting or ultrasonic welding of two or more layers to form a composite structure that will maintain its adhesion during use or the life of the device.

The term “control”, “controls” or “controlling” as used herein refers to any method utilized to manage the environment in footwear. For example, an application of a fluid to the device of the present invention that acts to reduce odor, mask odor, absorb odor or chemically modify the odorous compound to make it less detectible by smell.

The term “eliminate”, “eliminates” or “eliminating” as used herein refers to any method that prevents a condition occurring in footwear. For example, eliminating odors in footwear can include methods that kill the bacteria producing odorous compounds or converting the odorous compounds into non-odorous compounds by chemical processes. For example, an odorous compound may be chemically converted (e.g., an acid/base reaction) into a form that changes its vapor pressure and preventing it from entering the gaseous phase, making it undetectable by smell.

The term “essential oil” as used herein refers to a concentrated hydrophobic liquid containing volatile chemical compounds usually prepared from plants. Essential oils are also referred to as volatile oils, ethereal oils or simply as the oil of the plant from which they were extracted. In contrast to fatty oils, essential oils typically evaporate completely without leaving a stain or residue. Essential oils are generally extracted by distillation, often by using steam. Other processes include solvent extraction, absolute oil extraction, resin tapping, wax embedding, and cold pressing. Essential oils are often used for aromatherapy, a form of alternative medicine in which a variety of healing effects are ascribed to aromatic compounds.

The term “odorless” as used herein refers to the pad without an aqueous or oil-based fluid deposited thereon. For example, in reference to the device of the present invention, it does not mean that the pad itself contains no odor since the materials used to prepare the pad may have some residual odor. It means that no odorous compound has been deposited on the pad when the pad is manufactured. The pad is designed to receive a fluid (e.g., an essential oil), at the time of intended use by the consumer.

The term “mask”, “masks” or “masking” as used herein refers to the ability to cover, but not alter or eliminate a thing. For example, in the case of foot odor, masking may encompass application of a pleasant odor that overpowers an undesirable odor making it less detectable or unpleasant.

The term “natural biopolymer” as used herein refers to polymers produced by living organisms. Biopolymers are constructed of monomeric units that are covalently bonded to form larger structures. One class of biopolymers is polysaccharides. Three important polysaccharides, starch, glycogen and cellulose are composed of polymeric carbohydrate structures that are primarily composed of monomers of glucose. Other examples of biopolymers include suberin, melanin, and lignin.

The term “protective layer” as used herein refers to a covering over the absorbent layer that allows essential oils or other fluids applied to the pad to pass through, without being retained by this layer, and captured by the absorbent layer. More specifically, this layer allows the absorbent layer to retain the essential oils or other fluids while acting as a barrier that reduces continuous contact of the essential oils or other fluids with the skin during use.

The term “removable” or “removably” as used herein refers to the ability of the adhesive used with the pad of the present invention to adhere the pad to the inside of a shoe or interior of a sandal such that the pad remains in place during use and can later be disengaged from the shoe or sandal without damaging the surface on which it is adhered.

The present invention is a pad for the inside of a shoe or sandal able to receive and maintain an aqueous or oil-based fluid. The pad contains an absorbent layer for receiving an aqueous or oil-based fluid (e.g., essential oil) having an upper surface and a lower surface, an adhesive layer affixed to the absorbent layer to allow the pad to be affixed within a shoe or sandal and wherein the adhesive layer acts as an aqueous and oil impermeable layer, a removable protective cover affixed to the adhesive layer to prevent damage prior to use and a protective layer affixed over the absorbent layer to reduce or prevent the absorbent layer from contacting a user.

The device may be made in a variety of sizes and shapes that may be affixed to the inside of a shoe or sandal and be relatively undetectable during use. For example, the size may be about 1/20 to about 1/50 the size of the sole of a specific piece of footwear. More specifically, about 1/20, about 1/25, about, 1/30, about 1/35, about 1/40, about 1/45, or about 1/50 the size of the sole of the shoe or sandal to which the device is intended to be applied. The shape of the device may vary from geometrical (e.g., round, oval, square, rectangular, triangular, or modified shapes thereof) or they could be fanciful shapes (e.g., plant-shaped (leaf-shaped, flower-shaped, and the like), nut-shaped (almond-shaped, acorn-shaped and the like), shell-shaped (sand dollar-shaped, scallop-shaped and the like), fruit-shaped (apple-shaped, orange-shaped and the like), or cartoon character-shaped for children) or any shape desired by the user. The area encompassed by the device may be about 4 cm (e.g., 2 cm by 2 cm square) to about 25 cm (e.g., 5 cm by 5 cm square). More specifically, the area is about 4 cm, about 5 cm, about 6 cm, about 8 cm, about 10 cm, about 12 cm, about 14 cm, about 16 cm, about 18 cm, about 20 cm, about 22 cm or about 25 cm. The thickness of the device is from about 0.2 mm to about 4.0 mm. More specifically, the thickness of the device, absent the protective cover and sterile cover if present, is about 0.2 mm, about 0.3 mm, about 0.4 mm, about 0.5 mm, about 0.6 mm, about 0.8 mm, about 1.0 mm, about 1.3 mm, about 1.5 mm, about 1.8 mm, about 2.0 mm, about 2.2 mm, about 2.4 mm, about 2.6 mm, about 2.8 mm, about 3.0 mm, about 3.2 mm, about 3.4 mm, about 3.6 mm about 3.8 mm or about 4.0 mm.

The device of the present invention may further comprise an aqueous and oil impermeable layer between the adhesive layer and the absorbent layer, a transfer layer between the protective layer and the absorbent layer and/or a sterile cover over the protective layer.

### Absorbent Layer

The absorbent layer is a made of a material that is able to absorb and retain a fluid, whether aqueous or oil-based (e.g., an essential oil), within its matrix during the use of the device. The amount of the material provided will be sufficient to retain the volume proscribed based on the size of the device. The absorbent layer may be made of a fibrous material such as felt, woven and non-woven materials and/or fabrics. In one embodiment, this layer is made of a compostable natural material such as wood pulp, cotton or bamboo (e.g., cellulose). There are a variety of materials that perform this function known in the art particularly in the diaper and feminine sanitary pad industries. The thickness of this layer may range from about 0.5 mm to about 5.0 mm, from 0.8 mm to about 4.5 mm, from about 1.0 mm to about 4.0 mm, from about 1.2 mm to about 3.8 mm, from about 1.5 mm to about 3.5 mm, from about 2.0 mm to about 3.0 mm. More specifically, about 0.5 mm, about 0.8 mm, about 1.0 mm, about 1.3 mm, about 1.5 mm, about 1.7 mm about, 2.0 mm, about 2.3 mm, about 2.5 mm about 2.7 mm about 3.0 mm, about 3.3 mm, about 3.5 mm, about 3.7 mm, about 4.0 mm, about 4.3 mm, about 4.5 mm about 4.7 mm or about 5.0 mm. The volume of the aqueous or oil-based fluid applied to the pad will depend on the amount of the absorbent layer provided and the volume of fluid that amount of absorbent material can absorb without allowing the fluid to escape the pad. One skilled in the art can determine the amount a given volume of absorbent material will hold with routine testing. For example, if the pad has an area of about 4 cm with a 1.0 mm thickness of absorbent material, then it may retain about 2 drops (i.e., about 0.1 mL) to about 4 drops (i.e., about 0.3 mL) of an aqueous fluid. For a 25 cm pad with the same thickness of absorbent material may retain from about 0.6 mL to about 1.8 mL.

### Aqueous and Oil Impermeable Layer

The aqueous and oil impermeable sheet allows the device to maintain any aqueous or oil-based fluid that is deposited in the absorbent layer from exiting the device where the layer contacts the sole of the shoe or sandal. Natural biopolymers such as cellophane may be used for this purpose. The type and thickness of the biopolymer used depends on its ability to remain impermeable to the fluids or essential oils applied to the device as well as its ability to maintain this impermeability during use. One skilled in the art can test different types and thicknesses of selected biopolymers to determine the appropriate type and thickness to be used. For example, if cellophane is selected, then one skilled in the art can utilize a variety of thicknesses of cellophane as the aqueous and oil impermeable layer on test prototypes to determine which thickness would be appropriate for the designated application. The thickness can range from about 10 microns to about 250 microns, about 10 microns to about 100 microns, about 10 microns to about 50 microns or about 20 microns to about 40 microns. Thicknesses of about 10 microns, about 15 microns, about 20 microns, about 25 microns, about 30 microns, about 35 microns, about 40 microns, about 50 microns, about 100 microns, or about 250 microns may be utilized with the present invention. In one embodiment, it would be beneficial to utilize the thinnest possible layer of the biopolymer that performs the desired function and to assure that the device in its final form has a total thickness that is not uncomfortable during use.

In another embodiment, the aqueous and oil impermeable layer may be prepared by applying (e.g., spraying) a polymeric coating (e.g., a resin) on the base side of the absorbent layer instead of having a separate impermeable layer that is affixed to the absorbent layer. Alternatively, the polymeric coating applied to the base side of the absorbent layer may provide both the functions of being impermeable to aqueous and oil-based fluids and as an adhesive to adhere the device to a shoe or sandal. In this configuration, the device would not require an aqueous and oil impermeable layer as a separate element.

### Adhesive Layer

The adhesive layer is applied to the bottom side of the aqueous and oil impermeable layer and allows the user to affix the device to the sole or other area of the interior of a shoe or sandal. Any adhesive known in the art may be used that allows the device to be held firmly in place during use and removed from the sole without damaging the attachment area. The adhesive selected will depend on how long the device will remain in use before replacement, the ability of the adhesive to retain the device in the desired location within the shoe or sandal and its ability to be removed from the location without damaging the surface on which it is affixed. One skilled in the art can test a variety of commercially available adhesive to select those appropriate for these purposes. Adhesives that may be utilized with the present invention include solvent-based acrylic adhesives (e.g., Monsanto GMS 737 (Monsanto Corporation, St. Louis Mo.), National Starch Durotak 72-9720 and/or 1085-1197 (National Starch & Chemical Corporation, Bridgewater N.J.), Ashland's AROSET 1113-AF-40 and/or 1085-Z-45 (Ashland Oil Company, Ashland, Ky.)), solvent-based rubber adhesives (e.g., National Starch 36-6172 National Starch & Chemical Corporation, Bridgewater N.J.), acrylic emulsion adhesives (e.g., Monsanto GME 2397 (Monsanto Corporation, St. Louis Mo.), Rohm & Haas N580 (Rohm & Haas Company, Philadelphia, Pa.), Unocal 76 RES 9646 (Unocal Corporation, Los Angeles, Calif.), and/or Ashland's AROSET 2022-W-50 (Ashland Oil Company, Ashland, Ky.)), and/or transfer tape adhesives (e.g., 3M F-9465 PC (3M Company, St. Paul, Minn.), Avery-Denison MED 1116 (Avery Denison Corporation Pasadena, Calif.), ARCare7530 (Adhesive Research Inc., Glen Rock, Pa.) and/or RX230U (Coating Science Inc., Bloomfield, Conn.).

The adhesive may be applied over the entire surface of the aqueous and oil impermeable layer or it may be allocated to portions of the layer. For example, the adhesive may be applied along the perimeter edge of the sheet, in multiple thin stripes across the sheet, or in an even or uneven dotted pattern on the sheet. Further, the amount of the adhesive applied in these configurations will be sufficient to retain the device in place during use. In some instances, a particular configuration may be beneficial in conserving the amount of adhesive utilized or to assure that the area to which the device is affixed is not damaged upon removal. One skilled in the art can test a variety of adhesive design configurations to determine the best configuration and assure that the amount of adhesive applied is sufficient to maintain the device in place during use while at the same time preventing damage to the shoe or sandal when the device is removed.

In one embodiment, the adhesive also provides the function of being an aqueous and oil impermeable barrier and is applied (e.g., sprayed or rolled-on) to the base of the absorbent layer, thereby eliminating the need for an aqueous and oil impermeable layer.

### Removable Protective Cover

The removable protective cover is a temporary removable covering over the adhesive layer that protects the adhesive from damage prior to use. This layer may be provided with a tab or gripping element along its edge that allows the user to easily remove the cover without damaging the adhesive prior to applying the device to a shoe or sandal. The material used for the protective cover may adhere to the adhesive but is able to be disengaged easily without tearing or damaging the adhesive layer. Various types of protective covers are known in the art and may be tested to assure that the covering selected performs the desired function. For example, the cover may be made of high density polyethylene, polyester or polyethylene terephthalate.

### Protective Layer

The protective layer is made of a material that permits the fluid applied to the device to pass through to the absorbent layer below without retaining a substantial or significant amount of the fluid on its surface. This layer protects the user's skin from continuous contact with the fluid applied to the device during use. This may be provided as a separate sheet of protective layer material affixed to the top surface of the absorbent layer or it may be applied (e.g., sprayed or rolled) onto the top surface of the absorbent layer thereby eliminating the need for a separate protective layer sheet. There are a variety of materials that perform this function known in the art particularly in the diaper and feminine sanitary pad industries. These materials may be prepared as a felt or in a woven or knitted sheet. One skilled in the art may select the appropriate material by testing there function in the device. The desired material will retain none or only a minimal amount of the fluid applied to the device prior to use. If applied by spraying or rolling, the protective layer may be applied in a pattern such as a net or screen design or alternatively in a multiple raised dot configuration. One skilled in the art can select and test that pattern in the device to assure that the configuration selected obtains the desired results. The thickness of this layer may range from about 0.2 mm to about 0.05 mm. More specifically, about 0.05 mm, about 0.07 mm, about 0.10 mm, about 0.12 mm, about 0.13 mm, about 0.14 mm, about 0.15 mm, about 0.16 mm, about 0.17 mm, about 0.18 mm, about 0.19 mm or about 0.20 mm.

### Sterile Cover

The sterile cover is provided over the protective layer prior to use to prevent contamination of or damage to the device prior to use. This layer may be provided with a tab or gripping element along its edge that allows the user to easily remove the cover without damaging the device prior to use. Various types of sterile covers are known in the art and may be tested to assure that the covering selected performs the desired function. For example, the cover may be made of high density polyethylene, polyester or polyethylene terephthalate.

### Transfer Layer

The transfer layer may be provided between the absorbent layer and the protective layer. The purpose of this layer is to expedite the transfer of any fluid deposited on the protective layer to the absorbent layer. Consequently the transfer layer is made of a material having a structure that takes advantage of capillary action to move a fluid whether aqueous or oil-based deposited on the surface of the protective layer quickly into the absorbent layer. For example, natural fibers such as cotton or synthetic biodegradable lyocell fibers (e.g., TENCEL™ Biosoft, Lenzing Group, Lenzing, Austria) may be utilized for this purpose. The thickness of this layer may range from about 0.10 mm to about 0.20 mm. More specifically, about 0.10 mm, about 0.12 mm, about 0.13 mm, about 0.15 mm, about 0.17 mm or about 0.20 mm.

### Use

The device of the present invention may be assembled by a variety of methods known in the art utilized to adhere multiple layers of material together producing single pads or a sheet of pads from which a single pad may be easily removed prior to use. In one configuration where the device contains both a protective and sterile coverings, the user extracts a single pad from a package or removes a single pad from a sheet. The protective cover is removed from the adhesive and the device is adhered to the desired location within a shoe or sandal. Once affixed the user removes the sterile cover to expose the protective layer. After removing the sterile cover the user may apply a desired fluid to the device. This fluid may be an essential oil or a medicament that treats a foot condition of the user. For example, the fluid may provide a pleasant odor or create an environment that discourages fungal growth (e.g., Athlete's foot) or the like.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

I claim:

1. An odorless pad for the inside of a shoe or sandal able to receive and maintain an aqueous or oil-based fluid, said pad comprising:
an absorbent layer for receiving said aqueous or oil-based fluid having an upper surface and a lower surface;
an adhesive layer affixed to said lower surface of said absorbent layer to allow said pad to be bound in said shoe or sandal, wherein said adhesive layer acts as an aqueous and oil impermeable barrier;
a removable protective cover affixed to said adhesive layer to prevent damage prior to use; and
a protective layer affixed over said upper surface of said absorbent layer to reduce or prevent said absorbent layer from contacting a user.

2. The pad according to claim 1, further comprising a removable sterile cover fitted over said protective layer to maintain said pad in sterile form prior to use.

3. The pad according to claim 1, further comprising an aqueous and oil impermeable layer.

4. The pad according to claim 1, wherein said pad is less than about 1/20 to about 1/50 the size of said inside sole of said shoe.

5. The pad according to claim 1, wherein said protective layer is a natural biopolymer.

6. The pad according to claim 1, further comprising a transfer layer between said protective layer and said absorbent layer, wherein said transfer layer allows the transfer of said aqueous or oil-based fluid received by said pad to said absorbent layer.

7. The pad according to claim 6, wherein said transfer layer is made of a porous natural biopolymer.

8. The pad according to claim 7, wherein said porous natural biopolymer is porous wood pulp.

9. The pad according to claim 1, wherein said aqueous and oil impermeable layer is a compostable bioplastic.

10. The pad according to claim 1, wherein said aqueous and oil impermeable layer is cellophane.

11. The pad according to claim 1, wherein said adhesive is plant-based glue.

12. The pad according to claim 11, wherein said plant-based glue is dextrin.

13. The pad according to claim 1, wherein said removable protective cover is a polymer coated sheet.

14. The pad according to claim 13, wherein the polymer coated sheet is a polymer coated paper.

15. The pad according to claim 13, wherein the polymer is a natural or synthetic wax.

16. The pad according to claim 1, further comprising an essential oil.

17. A kit comprising:
one or more odorless pads for the inside of a shoe or sandal able to receive and maintain an aqueous or oil-based fluid, said pad comprising: an absorbent layer for receiving said aqueous or oil-based fluid having an upper surface and a lower surface; an aqueous and oil impermeable layer affixed to said lower surface of said absorbent layer; an adhesive layer affixed on said aqueous and oil impermeable layer, wherein said adhesive affixes said pad in said shoe or sandal; a removable protective cover affixed to said adhesive layer to prevent damage prior to use; and a protective layer affixed over said upper surface of said absorbent layer to reduce or prevent said absorbent layer from contacting a user; and
one or more containers, each of said containers containing an essential oil.

18. The kit according to claim 17, wherein said one or more pads further comprising a removable sterile cover fitted over said protective layer to maintain said pad in sterile form prior to use.

19. The kit according to claim 17, wherein said one or more pads are less than about 1/20 to about 1/50 the size of said inside sole of said shoe.

20. The kit according to claim 17, wherein said pad further comprising a transfer layer between said protective layer and said absorbent layer, wherein said transfer layer allows the transfer of said aqueous or oil-based fluid received by said pad to said absorbent layer.

21. A method of exposing the feet of a user to an aqueous or oil-based fluid when wearing shoes or sandals comprising the steps of:
obtaining an odorless pad for the inside of a shoe or sandal able to receive and maintain an aqueous or oil-based fluid, said pad comprising: an absorbent layer for receiving said aqueous or oil-based fluid having an upper surface and a lower surface; an aqueous and oil impermeable layer affixed to said lower surface of said absorbent layer; an adhesive layer affixed on said aqueous and oil impermeable layer, wherein said adhesive affixes said pad in said shoe or sandal; a removable protective cover affixed to said adhesive layer to prevent damage prior to use; and a protective layer affixed over said upper surface of said absorbent layer to reduce or prevent said absorbent layer from contacting a user;
applying said aqueous or oil-based fluid to said absorbent layer through said protective layer and allowing said aqueous or oil-based fluid to be absorbed by said absorbent layer;
removing said removable protective cover from said adhesive layer; and
affixing said pad in said shoe or sandal.

22. The method according to claim 21, wherein said pad further comprising a removable sterile cover fitted over said protective layer to maintain said pad in sterile form prior to use.

23. The method according to claim 21, wherein said pad is less than about 1/20 to about 1/50 the size of said inside sole of said shoe.

24. The method according to claim 21, wherein said pad further comprising a transfer layer between said protective layer and said absorbent layer, wherein said transfer layer allows the transfer of said aqueous or oil-based fluid received by said pad to said absorbent layer.
